(19) United States
(12) Patent Application Publication
(10) Pub. No.: US 2022/0116722 A1
(43) Pub. Date: Apr. 14, 2022

(54) CALIBRATION OF A SOUND SYSTEM

(71) Applicant: ARRIS Enterprises LLC, Suwanee, GA (US)

(72) Inventors: Virendra SINGH, Bangalore (IN); Vinod JATTI, Bangalore (IN)

(21) Appl. No.: 17/472,915

(22) Filed: Sep. 13, 2021

Related U.S. Application Data
(60) Provisional application No. 63/091,365, filed on Oct. 14, 2020.

(51) Int. Cl. H04R 29/00; G10L 25/51

(52) U.S. Cl. CPC H04R 29/001; G10L 25/51

(57) ABSTRACT

The installation and calibration of a sound system can be difficult or time-consuming for a user as a user typically cannot easily discern the optimal positioning or setting for sound system speaker. A sound system configuration device can receive one or more sound samples associated with one or more sound system speakers, such as from one or more microphones positioned at or about the sound system. These sound samples can be used to determine a calibration for the sound system. A calibration instruction based on the determined calibration can be provided, for example, via a notification to the user. The calibration instruction can include, for example, a suggested location for a sound system speaker, a suggested calibration setting for a component of the sound system, or both. The calibration instruction can also automatically update or modify a calibration setting for a component of the sound system.

### BACKGROUND

Companies are increasingly providing Multiple Access Point (MAP) architecture or Home Network Controller (HNC) type of home wireless fidelity (Wi-Fi) management, with multiple access point devices, extender access point devices, and/or client devices (collectively, network devices) within the home to improve Quality of Experience (QoE) of the user by offering extended coverage with seamless roaming. Access point devices and extender access point devices communicate with client devices using one or more RF channels.

Increasingly users are requiring easy installation and maintenance of all types of network devices that connect to the network. For example, users may install a sound system that interfaces with one or more network devices, such as to stream content. However, users may not install the sound system properly or make calibrations to the sound system so as to maximize the performance of the sound system. This can lead to the user incorrectly assuming that the connectivity or an element/component of the sound system is not operating properly which can lead to erroneous complaints or feedback from the user and diminish the QoE of the user.

Therefore, there is a need to provide assistance to the user for installation and calibration of a sound system within a network environment.

### SUMMARY

Network environments, especially home network environments, can now serve multiple functions for various types of users, network devices, network applications, etc. For example, the same network can be required to support a variety of users and network devices such as a sound system that interfaces with one or more network devices, such as an entertainment system. In many network environments, an entertainment system can include a sound system with the sound system playing an important role in the presentation of entertainment. For example, in a home ecosystem, the sound system provides a high quality sound experience for a user while watching multi-media content streamed to a coupled network device, such as a television. However, a user may not be fully aware of the optimal configuration for the sound system. The user may fail to configure (for example, set, calibrate or install) the sound system properly and thus the user will experience a poor QoE and can perceive poor sound quality. For example, many sound systems require that the user set or calibrate one or more configuration parameters including, but not limited to any of entering or adjusting one or more settings of one or more connected network devices, such as a multi-media device or set-top box, installation or positioning of one or more speakers at one or more strategic locations, calibration of the one or more speakers, any other configuration parameters, or combination thereof. If the one or more configuration parameters are not properly set or performed, the user can experience poor quality sound or an unsatisfactory audio playback experience. Such can lead to costly user complaints, negative feedback, return of equipment, or any other negative action.

The present disclosure provides novel solutions for addressing the configuration of a sound system by implementing a sound system configuration application of a network device to assist or provide feedback to a user on the configuration or calibration of the sound system configuration device. As individuals generally cannot measure or calibrate the quality of a sound system without assistance from an electronic device, the sound system configuration application can provide for calibration, feedback (such as prompts or instructions to the user), automatic or dynamic sound quality monitoring and adjustment, or any other configuration assistance so that the sound system is configured to provide an optimal sound quality experience for the user.

An aspect of the present disclosure provides a sound system configuration device for providing calibration of a sound system. The sound system configuration device comprises a memory storing one or more computer-readable instructions and a processor configured to execute the one or more computer-readable instructions to collect one or more sound samples from an input source, wherein the one or more sound samples are associated with one or more sound system speakers of the sound system, analyze a quality level of the one or more sound samples, determine a calibration for the sound system based on the quality level, wherein the calibration comprises one or more calibration settings associated with the sound system, and provide one or more calibration instructions based on the calibration.

In an aspect of the present disclosure, the processor of the sound system configuration device is further configured to execute the one or more instructions to identify one or more current locations associated with the one or more sound system speakers, wherein the analyzing the quality level is based, at least in part, on the one or more current locations.

In an aspect of the present disclosure, the sound system configuration device further comprises a plurality of microphones, wherein the input source comprises the plurality of microphones.

In an aspect of the present disclosure, the sound system configuration device such that the input source comprises a plurality of microphones associated with one or more network devices communicatively coupled to the sound system configuration device.

In an aspect of the present disclosure, the sound system configuration device such that analyzing the quality level comprises sending the one or more sound samples to a network resource and receiving from the network resource the quality level.

In an aspect of the present disclosure, the sound system configuration device such that determining the calibration comprises determining a location of at least one of the one or more sound system speakers.

In an aspect of the present disclosure, the processor of the sound system configuration device is further configured to execute the one or more instructions to receive one or more specification parameters associated with the one or more sound system speakers, wherein the determining the calibration is based, at least in part, on the specification parameters.

An aspect of the present disclosure provides a method for a sound system configuration device for providing calibration of a sound system comprising collecting one or more sound samples from an input source, wherein the one or more sound samples are associated with one or more sound system speakers of the sound system, analyzing a quality level of the one or more sound samples, determining a calibration for the sound system based on the quality level, wherein the calibration comprises one or more calibration settings associated with the sound system, and providing one or more calibration instructions based on the calibration.

In an aspect of the present disclosure, the method further comprises identifying one or more current locations associated with the one or more sound system speakers, wherein the analyzing the quality level is based, at least in part, on the one or more current locations.

In an aspect of the present disclosure, the method is such that the input source comprises a plurality of microphones of the sound system configuration device, a plurality of microphones of one or more network devices coupled to the sound system configuration device, or a combination thereof.

In an aspect of the present disclosure, the method further comprises receiving a request from a service provider to initiate the collecting the one or more sound samples.

In an aspect of the present disclosure, the method is such that analyzing the quality level comprises sending the one or more sound samples to a network resource and receiving from the network resource the quality level.

In an aspect of the present disclosure, the method is such that determining the calibration comprises determining a location of at least one of the one or more sound system speakers.

In an aspect of the present disclosure, the method further comprises receiving one or more specification parameters associated with the one or more sound system speakers, wherein the determining the calibration is based, at least in part, on the specification parameters.

An aspect of the present disclosure provides a non-transitory computer-readable medium of a sound system configuration device storing one or more instructions for providing calibration of a sound system. The one or more instructions when executed by a processor of the sound system configuration device, cause the sound system configuration device to perform one or more operations including the steps of the methods described above.

The above-described network device(s) or electronic apparatus(es), such as access point devices, extender access point devices, client devices and any other network devices, may be implemented as any of a residential network access point device, an electronic device (for example, a mobile phone, a computing device such as a notebook computer, or both) according to one or more embodiments. Throughout this disclosure the term speaker is used to generally refer to any device that receives an audio input, whether analog or digital, and converts the audio input into one or more sound waves.

Thus, according to various aspects of the present disclosure described herein, it is possible to provide calibration of a sound system by utilizing a network device as a sound system configuration device. The sound system configuration device can provide for configuring of the sound system so to ensure an enhanced QoE to a user without requiring the user to have specialized skills or to obtain additional equipment.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of an exemplary access point device, network device, and extender access point device implemented in the network environment of FIG. 1, according to one or more aspects of the present disclosure;

FIG. 3 is a more detailed block diagram illustrating certain components implemented in a sound system environment for providing calibration of a sound system, according to one or more aspects of the present disclosure; and

FIG. 4 is a flow chart illustrating a method for providing calibration of a sound system, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

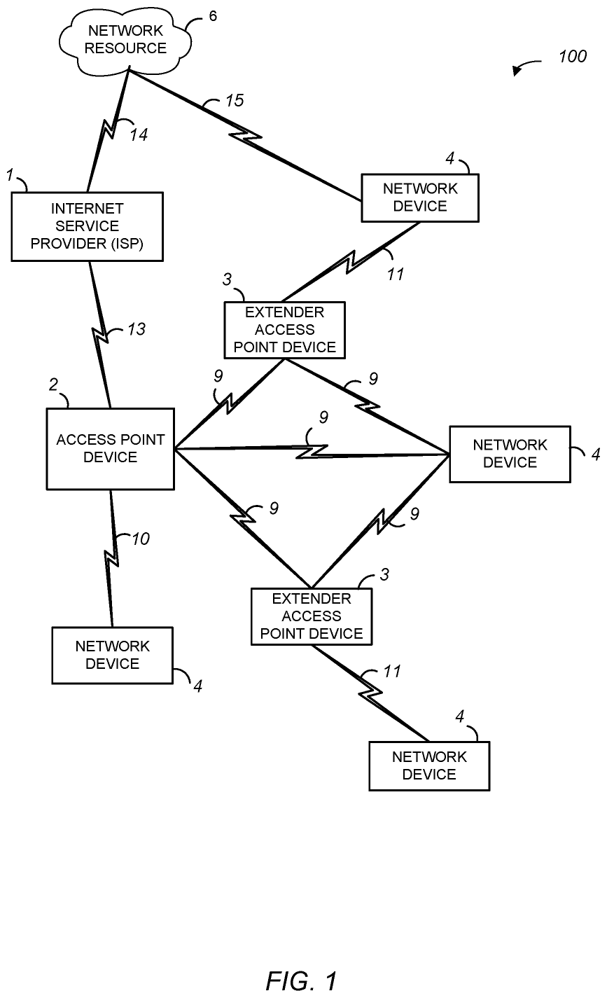

FIG. 1 is a schematic diagram of a network environment 100, according to one or more aspects of the present disclosure.

It should be appreciated that various example embodiments of inventive concepts disclosed herein are not limited to specific numbers or combinations of electronic or network devices, and there may be one or multiple of some of the aforementioned electronic apparatuses or network devices in the network environment, which may itself consist of multiple communication networks and various known or future developed wireless connectivity technologies, protocols, devices, and the like.

As shown in FIG. 1, the main elements of the network environment 100 include a network comprising an access point device 2 connected to a network resource 6, such as a cloud-based repository, via an Internet Service Provider (ISP) 1 and also connected to different wireless devices or network devices such as one or more wireless extender access point devices 3 and one or more network devices 4. The network environment 100 shown in FIG. 1 includes wired and/or wireless network devices (e.g., extender access point devices 3 and network devices 4) that may be connected in one or more wireless networks (e.g., private, guest, iControl, backhaul network, or Internet of things (IoT) network) or one or more wired networks within the network environment 100. Additionally, there could be some overlap between network devices (e.g., extender access point devices 3 and network devices 4) in the different networks. That is, one or more network or wireless devices could be located in more than one network. For example, the extender access point devices 3 could be located both in a private network for providing content and information to one or more other network devices 4 and also included in a backhaul network or an iControl network.

Starting from the top of FIG. 1, the ISP 1 can be, for example, a content provider or any computer for connecting the access point device 2 to the network resource 6. For example, network resource 6 can be a cloud-based service that provides access to a cloud-based repository accessible via ISP 1 where the cloud-based repository comprises information associated with any one or more network devices of the network environment 100, for example, a sound system configuration application that provides configuration or calibration information for a sound system within or in proximity of one or more network devices of the network environment 100. In one or more embodiments, network resource 6 can be associated with the provider of the access point device 2, any one or more network devices 4, the extender access point device 3, any one or more other devices within the network environment 100, or any combination thereof. In one or more embodiments, the network resource 6 can be included with or as part of the ISP 1. The connection 14 between the network resource 6 and the ISP 1 and the connection 13 between the ISP 1 and the access point device 2 can be implemented using a wide area network (WAN), a virtual private network (VPN), metropolitan area networks (MANs), system area networks (SANs), a data over cable service interface specification (DOCSIS) network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, or 6G network, for example.

The connection 13 can further include as some portion thereof a broadband mobile phone network connection, an optical network connection, or other similar connections. For example, the connection 13 can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that connection 13 is capable of providing connections between the access point device 2 and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G or 6G network, for example

The access point device 2 can be, for example, an access point and/or a hardware electronic device that may be a combination modem and gateway that combines the functions of any of a modem, an access point (AP), a router, or combinations thereof for providing content received from the ISP 1 to one or more network devices (e.g., wireless extender access point devices 3 and network devices 4) in the network environment 100. In one or more embodiments, the access point device 2 can comprise a network device 4 that provides sound system configuration or calibration for a sound system of the network environment 100. It is also contemplated by the present disclosure that the access point device 2 can include the function of, but is not limited to, a universal plug and play (UPnP) simple network management protocol (SNMP), an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The access point device 2 may also be referred to as a residential gateway, a home network gateway, or a wireless access point (AP).

The connection 9 between the access point device 2, the wireless extender access point devices 3, and network devices 4 can be implemented using a wireless connection in accordance with any IEEE 802.11 Wi-Fi protocols, Bluetooth protocols, BLE, or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, or 60 GHz bands. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more of connections 9 can carry information on any of one or more channels that are available for use. In one or more embodiments, one or more network devices (such as any of the one or more extender access point devices 3, the one or more network device 4, or a combination thereof) and/or the access point device 2 provide for configuration or calibration of a sound system associated with, for example, a client device or other device within the network environment 100.

The extender access point devices 3 can be, for example, wireless hardware electronic devices such as access points (APs), extenders, repeaters, etc. used to extend the wireless network by receiving the signals transmitted by the access point device 2 and rebroadcasting the signals to, for example, network devices 4, which may be out of range of the access point device 2. The extender access point devices 3 can also receive signals from the network devices 4 and rebroadcast the signals to the access point device 2, or other network devices 4.

The connection 11 between the extender access point devices 3 and the client devices 4 are implemented through a wireless connection that operates in accordance with any IEEE 802.11 Wi-Fi protocols, Bluetooth protocols, Bluetooth low energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. Additionally, the connection 11 can be implemented using a wireless connection that operates in accordance with, but is not limited to, RF4CE protocol, ZigBee protocol, Z-Wave protocol, or IEEE 802.15.4 protocol. Also, one or more of the connections 11 can be a wired Ethernet connection. Any one or more connections 11 can carry information on any one or more channels that are available for use.

A network device 4 can be, for example, any type of electronic or computing device including, but not limited to, a set-top box, a smart media device, any of a hand-held device, personal computers, electronic tablets, mobile phones, smart phones, smart speakers, Internet-of-Things (IoT) devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the access point device 2. In one or more embodiments, the network device 4 can comprise any of a router, a gateway, a microphone, a speaker, a communications portal, a repository, or a combination thereof. In one or more embodiments a network device 4 can comprise any of a sound system configuration device for providing configuration or calibration of a sound system of the network environment 100, communicating with a network resource 6 that provides configuration or calibration of the sound system, collecting one or more sound samples from one or more network devices 4, or any combination thereof. Additionally, any one or more network devices 4 can be a television (TV), an IP/QAM set-top box (STB) or a streaming media decoder that is capable of decoding audio/video content, and playing over OTT or MSO provided content received through the access point device 2. Further, a network device 4 can provide output to a sound system for playback of the received audio content.

The connection 10 between the access point device 2 and the network device 4 is implemented through a wireless connection that operates in accordance with, but is not limited to, any IEEE 802.11 protocols. Additionally, the connection 10 between the access point device 2 and the network device 4 can also be implemented through a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G or 6G network, for example. The connection 10 can also be implemented using a wireless connection in accordance with Bluetooth protocols, BLE, or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. One or more of the connections 10 can also be a wired Ethernet connection.

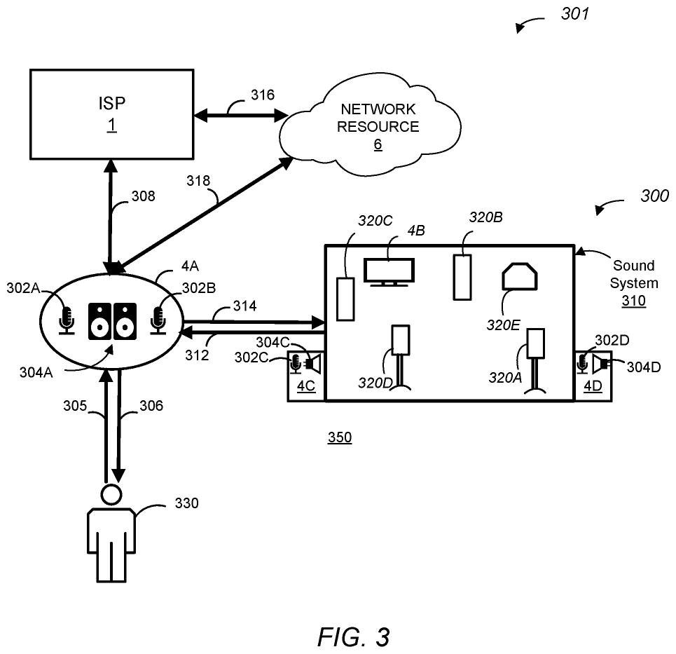

The connection 15 between the network device 4 and the network resource 6 can be any type of connection discussed herein. For example, the network resource 6 can be the same provider of the network device 4 and a backend connection 15 can be established between the network resource 6 and the network device 4. In one or more embodiments, a network device 4 can be coupled to an ISP 1 and a network resource 6, for example, as discussed with reference to FIG. 3.

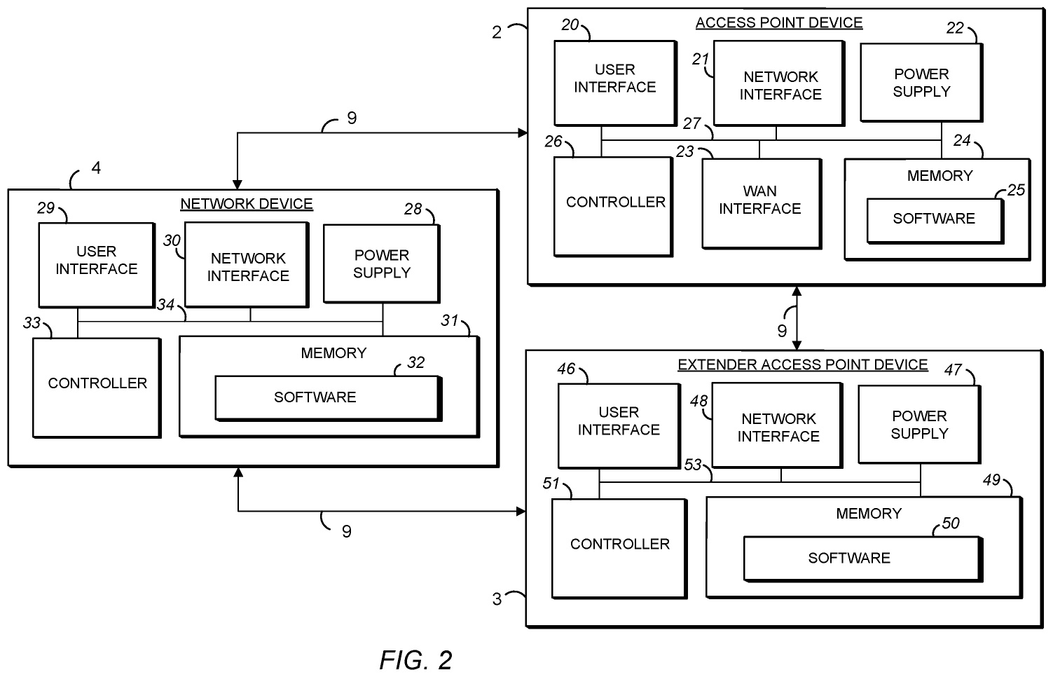

A detailed description of the exemplary internal components of the access point device 2, the extender access point devices 3, and the client devices 4 shown in FIG. 1 will be provided in the discussion of FIG. 2. However, in general, it is contemplated by the present disclosure that the access point device 2, the extender access point devices 3, and the network devices 4 include electronic components or electronic computing devices operable to receive, transmit, process, store, and/or manage data and information associated with the network environment 100, which encompasses any suitable processing device adapted to perform computing tasks consistent with the execution of computer-readable instructions stored in a memory or a computer-readable recording medium (e.g., a non-transitory computer-readable medium).

Further, any, all, or some of the computing components in the access point device 2, the extender access point devices 3, and the network devices 4 may be adapted to execute any operating system, including Linux, UNIX, Windows, MacOS, DOS, and ChromOS as well as virtual machines adapted to virtualize execution of a particular operating system, including customized and proprietary operating systems. The access point device 2, the extender access point devices 3, and the network devices 4 are further equipped with components to facilitate communication with other computing devices or network devices over the one or more network connections to local and wide area networks, wireless and wired networks, public and private networks, and any other communication network enabling communication in the network environment 100.

FIG. 2 is a more detailed block diagram illustrating various components of an exemplary access point device 2, network device 4, and wireless extender access point device 3 implemented in the network environment 100 of FIG. 1, according to one or more aspects of the present disclosure.

Although FIG. 2 only shows one extender access point device 3 and one network device 4, the extender access point device 3 and the network device 4 shown in the figure are meant to be representative of the other extender access point devices 3 and network devices 4 of a network system, for example, network environment 100 shown in FIG. 1. Similarly, the connections 9 between the access point device 2, the extender access point device 3, and the network device 4 shown in FIG. 2 are meant to be exemplary connections and are not meant to indicate all possible connections between the access point devices 2, extender access point devices 3, and network devices 4. Additionally, it is contemplated by the present disclosure that the number of access point devices 2, extender access point devices 3, and network devices 4 is not limited to the number of access point devices 2, extender access point devices 3, and network devices 4 shown in FIGS. 1 and 2.

Now referring to FIG. 2 (e.g., from left to right), the network device 4 includes a power supply 28, a user interface 29, a network interface 30, a memory 31, and a controller 33.

The power supply 28 supplies power to the internal components of the network device 4 through the internal bus 34. The power supply 28 can be a self-contained power source such as a battery pack with an interface to be powered through an electrical charger connected to an outlet (e.g., either directly or by way of another device). The power supply 28 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 29 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user and the network device 4, for example, for a user to enter any one or more settings or parameters that are stored in memory 31, for example, one or more configuration parameters associated with a sound system. In one or more embodiments, user interface 29 provides an interface for a user, such as a graphical user interface, to interact with a sound system configuration application, for example, software 32 stored in memory 31. The network interface 30 can include, but is not limited to, various network cards, interfaces, and circuitry implemented in software and/or hardware to enable communications with any of the access point device 2, the extender access point device 3, an ISP 1, a network resource 6, or any combination thereof using any one or more of the communication protocols in accordance with any one or more connections as described with reference to FIG. 1.

The memory 31 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), an optical storage, a hard disk or any other various layers of memory hierarchy. The memory 31 can be used to store any type of instructions, software, or algorithms including software 32 for controlling the general function and operations of the network device 4 in accordance with the embodiments described in the present disclosure. In one or more embodiments, memory 31 can store a sound system configuration application, an interface to a sound system configuration application of the network resource 6, or both. The memory 31 can further store an application that allows the access point device 2 to control, configure and/or maintain a network connection with the network device 2. In one or more embodiments, network device 4 is an electronic device that can receive or collect one or more sound samples, for example, one or more sound samples associated with a sound system, and software 32 includes one or more instructions for providing a calibration, installation, configuration, or any combination thereof of a sound system of the network environment.

The controller 33 controls the general operations of the network device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 32 for controlling the operation and functions of the network device 4 and/or configuration or calibration of a sound system in accordance with the embodiments described in the present disclosure. Communication between the components (e.g., 28-31 and 33) of the network device 4 may be established using an internal bus 34.

In one or more embodiments, software 32 includes a sound system configuration application that allows the network device to dynamically, automatically, and/or via a user interface configure a sound system of the network environment 100. In one or more embodiments, the sound system configuration application can provide via a user interface 29 a prompt to a user to initiate a configuration where configuration can include, but is not limited to, information, data, and/or instructions associated with a monitoring, a setting, a configuration, an installation, a calibration, or any combination thereof of the sound system. In one or embodiments, the sound system configuration application can monitor sound quality of a sound system and automatically or dynamically alter or adjust one or more configurations (such as a monitoring, a setting, a configuration, an installation, a calibration, or any combination thereof) of the sound system, provide a notification to a user, or both. For example, the sound system configuration application can analyze one or more collected or received sound samples to provide one or more configurations for the sound system. In one or more embodiments, the network device 4 communicates to a network resource 6 via the extender access point device 3, the access point device 2 or via a direct connection 15 the one or more sound samples such that the network resource 6 performs the analysis of the one or more collected or received sound samples and provides the one or more configurations or calibrations to the network device 4. In one or more embodiments, any functionality of the sound system configuration application can be implemented in part or in whole by any of the access point device 2, the extender access point device 3, the network device 4, or the network resource 6.

As shown in FIG. 2, the extender access point device 3 includes a user interface 46, a power supply 47, a network interface 48, a memory 49, and a controller 51.

The user interface 46 can include, but is not limited to, push buttons, a keyboard, a keypad, an LCD, a TFT, an LED, an HD or other similar display device including a display device having touch screen capabilities so as to allow interaction between a user and the extender access point device 3. The power supply 47 supplies power to the internal components of the wireless extender access point device 3 through the internal bus 53. The power supply 47 can be connected to an electrical outlet (e.g., either directly or indirectly by way of another device) via a cable or wire.

The network interface 48 can include various network cards, interfaces, and circuitry implemented in software and/or hardware to enable communications with the network device 4 and the access point device 2 using the communication protocols in accordance with connection 9 (e.g., as described with reference to FIG. 1). For example, the network interface 48 can include multiple radios or sets of radios (e.g., a 2.4 GHz radio, one or more 5 GHz radios, and/or a 6 GHz radio), which may also be referred to as wireless local area network (WLAN) interfaces. One radio or set of radios (e.g., 5 GHz and/or 6 GHz radio(s)) provides a backhaul connection between the wireless extender access point device 3 and the access point device 2, and optionally other wireless extender access point device(s) 3. Another radio or set of radios (e.g., 2.4 GHz, 5 GHz, and/or 6 GHz radio(s)) provides a fronthaul connection between the extender access point device 3 and one or more network device(s) 4.

The memory 49 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 49 can be used to store any type of instructions, software, or algorithm including software 50 associated with controlling the general functions and operations of the wireless extender access point device 3 in accordance with the embodiments described in the present disclosure. In one or more embodiments, extender access point device 3 is a network device and software 50 includes one or more instructions for establishing a connection with the access point device 2 and/or a network device 4.

The controller 51 controls the general operations of the wireless extender access point device 3 and can include, but is not limited to, a CPU, a hardware microprocessor, a hardware processor, a multi-core processor, a single core processor, an FPGA, a microcontroller, an ASIC, a digital signal processor (DSP), or other similar processing device capable of executing any type of instructions, algorithms, or software for controlling the operation and functions of the wireless extender access point device 3 in accordance with the embodiments described in the present disclosure. General communication between the components (e.g., 46-51) of the extender access point device 3 may be established using the internal bus 53.

As shown in FIG. 2, the access point device 2 includes a user interface 20, a network interface 21, a power supply 22, a wide area network (WAN) interface 23, a memory 24, and a controller 26.

The user interface 20 can include, but is not limited to, one or more push buttons, a keyboard, a keypad, an LCD, a TFT, an LED, an HD or other similar display device including a display device having touch screen capabilities so as to allow interaction between a user and the access point device 2. In one or more embodiments, the user interface 20 provides an interface, such as a command-line interface, a graphical user interface, an application programming interface (API), an interface output port for connection to a display, and/or an other type of user interface, that allows a user to interface with the access point device 2.

The network interface 21 may include various network cards, and circuitry implemented in software and/or hardware to enable communications with the extender access point device 3 and the network device 4 using the communication protocols in accordance with connection 9 (e.g., as described with reference to FIG. 1). Additionally, the various network cards, interfaces, and circuitry of the network interface 21 enable communications with a network device 4 (e.g., a mobile device) using the one or more communication protocols in accordance with connection 10 (e.g., as described with reference to FIG. 1). For example, the network interface 21 can include an Ethernet port (also referred to as a LAN interface) and multiple radios or sets of radios (e.g., a 2.4 GHz radio, one or more 5 GHz radios, and/or a 6 GHz radio, also referred to as WLAN interfaces). One radio or set of radios (e.g., 5 GHz and/or 6 GHz radio(s)) provides a backhaul connection between the access point device 2 and the wireless extender access point device(s) 3. Another radio or set of radios (e.g., 2.4 GHz, 5 GHz, and/or 6 GHz radio(s)) provides a fronthaul connection between the access point device 2 and one or more network devices 4. In one or more embodiments, the network interface 21 interfaces with a network resource 6. In one or more embodiments, network resource 6 can be local to and/or remote from the access point device 2.

The power supply 22 supplies power to the internal components of the access point device 2 through the internal bus 27. The power supply 22 can be connected to an electrical outlet (e.g., either directly or by way of another device) via a cable or wire.

The wide area network (WAN) interface 23 may include various network cards, and circuitry implemented in software and/or hardware to enable communications between the access point device 2 and the ISP 1 using the wired and/or wireless protocols in accordance with connection 13 (e.g., as described with reference to FIG. 1).

The memory 24 includes a single memory or one or more memories or memory locations that include, but are not limited to, a RAM, a DRAM, a memory buffer, a hard drive, a database, an EPROM, an EEPROM, a ROM, a flash memory, one or more logic blocks of a FPGA, hard disk or any other various layers of memory hierarchy. The memory 24 can be a non-transitory computer-readable storage medium used to store any type of instructions, software, or algorithm including software 25 for providing configuration or calibration of a sound system of the network environment 100.

The controller 26 controls the general operations of the access point device 2 including interfacing with other network devices (wireless extender access point devices 3 and network devices 4) in the network. The controller 26 can include, but is not limited to, a central processing unit (CPU), a network controller, a hardware microprocessor, a hardware processor, a multi-core processor, a single core processor, a FPGA, a microcontroller, an ASIC, a DSP, or other similar processing device capable of executing any type of instructions, algorithms, or software including the software 25 for configuration or calibration of a sound system in accordance with the embodiments described in the present disclosure. Communication between the components (e.g., 20-24, and 26) of the access point device 2 may be established using the internal bus 27. The controller 26 may also be referred to as a processor, generally.

FIG. 3 is a more detailed block diagram of a network environment 301 illustrating certain components of a sound system environment 300 for providing configuration or calibration of a sound system 310, according to one or more aspects of the present disclosure.

Network environment 301 can be similar to or the same as a network environment 100 of FIG. 1. The network environment 300 can include an ISP 1, a network resource 6, and a sound system environment 300. The sound system environment 300 at a site 350 can include any of a sound system 310, a network device 4A (such as sound system configuration device 4A), a network device 4B (such as a television 4B), one or more network devices 4C and 4D (such as receiver devices 4C and 4D, respectively). The sound system 310 can include one or more components, such as any of one or more sound system speakers 320A, 320B, 320C, 320D and 320E, collectively referred to as sound system speakers 320. In one or more embodiments, the sound system 310 can include a home theater surround sound system. The one or more sound system speakers 320 can be arranged, disposed or positioned at or about a site 350. In one or more embodiments, the one or more sound system speakers 320 are arranged as illustrated in FIG. 3. The present disclosure contemplates, though, any arrangement of the one or more sound system speakers 320 including, but not limited to, any of on a pedestal or pole (for example, sound system speakers 320A and 320D), within or as part of an enclosure (for example, sound system speakers 320B and 320C), mounted on a wall or other structure, at or on a floor or ground (for example, sound system speaker 320E), at or on any other supporting structure (for example, a table, a shelf, a bookcase, etc.), or a combination thereof.

In one or more embodiments, the client device 4B is coupled to or part of the sound system 310. In one or more embodiments, client device 4B can also include one or more internal speakers. The client device 4B can, for example, include any playback device for content received from ISP 1, for example, a television, a stereo, a receiver, or any other playback or media device that provides playback of audio content/sound.

The one or more receiver devices 4C and 4D can include one or more input sources, such as microphones 302C and 302D, respectively, and one or more output sources, such as speakers 304C and 304D, respectively. The one or more receiver devices 4C and 4D can be arranged, disposed or positioned at or about the sound system 310 to receive one or more sound samples 312 associated with the sound system 310 or any other network device 4. The one or more receiver devices 4C and 4D can be at a location at site 350 so as to receive the one or more samples 312 from the perspective of a user 330, for example, at a height and/or distance from client device 4B so as to emulate a user 330 consuming content displayed at the client device 4B. The one or more speakers 304C/304D can sense, collect or receive the one or more sound samples 312 associated with the sound system 310 and send the one or more sound samples 312 to the client device 4A. While FIG. 3 only shows two receiver devices 4C and 4D, the present disclosure contemplates any number of receiver devices.

In one or more embodiments, the sound system configuration device 4A can include one or more input devices or sources, such as microphones 302A and 302B, one or more output devices or sources, such as speakers 304A or 304B, a software 32 that comprises a sound system configuration application, a sound system configuration application interface to a sound system configuration application at a network resource 6, or both, any other component, or a combination thereof. In one or more embodiments, any of the one or more speakers 304A and 304B, the microphones 302A and 302B, or any combination thereof, can be internal to or coupled to the sound system configuration device 4A. In one or more embodiments, any of the one or more microphones 302A/302B of sound system configuration device 4A, the microphone 302C of receiver device 4C, the microphone 302D of receiver device 4D, or any combination thereof can comprise an array of microphones for collecting or receiving any of the one or more sound samples 312.

In one or embodiments, sound system configuration device 4A can be in communication with or otherwise coupled to any of one or more receiver devices 4C and 4D, one or more components of the sound system 310 (for example, any of one or more sound system speakers 320), any other speakers, any other network devices (for example, client device 4B), or a combination thereof. Sound system configuration device 4A can receive or collect one or more sound samples 312, such as any sound or audio input, that is output from any one or more output sources. The one or more output sources can include, but are not limited to, any of one or more sound system speakers 320, any other one or more speakers, or a combination thereof. The one or more sound samples 312 can be received at any one or more input sources. The one or more input sources can include, but are not limited to, any of microphones 302A, 302B, 302C, 302D, any other sound input device, or any combination thereof. The sound system configuration device 4A can process or analyze the one or more sound samples 312 from the input source, send the one or more sound samples 312 to a network resource 6 either directly or indirectly via ISP 1, or both.

In one or more embodiments, the sound system configuration device 4A can initiate an acoustics sampling such that a sound is output at any one or more output sources and received at any one or more input sources. For example, the sound system configuration device 4A can cause a sound to be output at a speaker 304A, a speaker 304C, a speaker 304D, or a combination thereof. In this way, the acoustics of a site 350 can be analyzed or tested prior to installation, configuration, or calibration of a sound system 310.

In one or more embodiments, a user 330 can acquire a sound system 310 or one or more components of a sound system 310. The user 330 can install the sound system 310 at a site 350 based on any one or more configuration parameters including, but not limited to, any of size of available space at site 350, type of sound system 310 (for example, a manufacturer identification such as a make and/or model), number and/or type of components of sound system 310, one or more user preferences, one or more acoustic parameters, any other parameter or a combination thereof. In one or more embodiments, a user interface 29 of the sound system configuration device 4A can prompt the user 330 for any of the one or more configuration parameters, query a network resource 6, or both. For example, the sound system configuration device 4A can prompt the user 330 for dimensions of a site 350 and the make/model of the sound system 310, query the network resource 6 for one or more specification parameters associated with the make/model of the sound system 310, or any combination thereof. The sound system configuration device 4A can provide one or more calibration instructions 314 based on a determined calibration, the one or more configuration parameters, or a combination thereof. For example, the one or more calibration instructions 314 can comprise any of one or more notifications to the user (such as one or more instructions associated with the installation of the sound system 310), one or more calibration settings associated with one or more components of the sound system 310 (for example, one or more sound system speakers 320), or any combination thereof. The one or more calibration instructions 314 can be sent to one or more users 330, one or more network devices 4, one or more components of the speaker system 310, or any combination thereof where the one or more calibration instructions 314 comprise any of an installation instruction for the sound system 310 (for example, a placement location for one or more components of the sound system 310), one or more calibration settings associated with one or more components of the sound system 310, or any combination thereof. For example, the sound system calibration device 4A can broadcast to the user 330 about current quality of the sound system 310, for example, to guide the user 330 with instructions to improve the quality of the sound system 310. In one or more embodiments, a customer or a user 330 can ask interactive questions to, for example, sound system configuration device 4A about how to place the speakers and check the current quality level of the sound system 310.

In one or more embodiments, the user 330 can initiate a sound system calibration application at a sound system calibration device 4A. The sound system calibration device 4A can identify one or more input sources associated with the sound system 310. For example, the sound system calibration device 4A can determine that any of speakers 304A, 304C, or 304D can be an input source. The sound system calibration application can cause the collection of one or more sound samples 312 from any of the one or more identified input sources. The sound system calibration application of a sound system calibration device 4A can use the one or more sound samples 312 to determine an optimal calibration for the sound system 310. For example, the sound system calibration application can analyze a quality level of the one or more sound samples 312 and based on the quality level or quality determination determine an optimal calibration for the sound system 310. The calibration can comprise one or more calibration settings associated with any one or more sound system speakers 320 including, but not limited to, any of a speaker location (such as a distance from any one or more sound system speakers, a client device 4B, a height, an angle, etc.), a sound setting (such as a sound level, a bass setting, a treble setting, etc. associated with a speaker 320 or any other component of the sound system 310), any other setting as provided by a specification parameter associated with the make/model of any component of the sound system 310, or a combination thereof. The sound system configuration device 4A can provide one or more calibration instructions 314 that are based on the determined calibration. The one or more calibration instructions 314 can comprise one or more notifications to the user (for example, one or more notifications displayed at the user interface 29), one or more calibration instructions 314 to one or more network devices 4 (for example, one or more instructions to alter, manage, or update one or more aspects of the network device), one or more calibration instructions 314 to any one or more components of the sound system 310, or any combination thereof.

In one or more embodiments, the network resource 6 comprises a sound system configuration application and the sound system configuration device 4A comprises a sound system configuration application interface such that the sound system configuration device 4A provides information including, but not limited to, any of one or more configuration parameters, one or more sound samples 312, one or more user inputs from user 330, any other information, or a combination thereof to the network resource 6. The network resource 6 can comprise a repository that includes optimal settings for one or more specification parameters associated with a given sound system 310, for example, based on a make/model of the sound system 310. In one or more embodiments, the network resource 6 interfaces with a remote repository, for example, a remote repository hosted by the manufacturer, supplier, vendor, and/or other data aggregator, to obtain the necessary information to determine a calibration for the specific sound system 310. The network resource 6 provides the one or more calibration instructions 314 (as discussed with respect to sound system configuration device 4A) to the sound system configuration device 4A. For example, the network resource 6 can have a two-way communication 318 with sound system configuration device 4A, a two communication 316 with ISP 1 and ISP 1 having a two-communication 308 with sound system configuration device 4A, or both. In one or more embodiments, the network resource 6 is associated with a network device 4, for example, network resource 6 is a cloud repository associated with the network device 4 and/or can be associated with the same vendor or manufacturer.

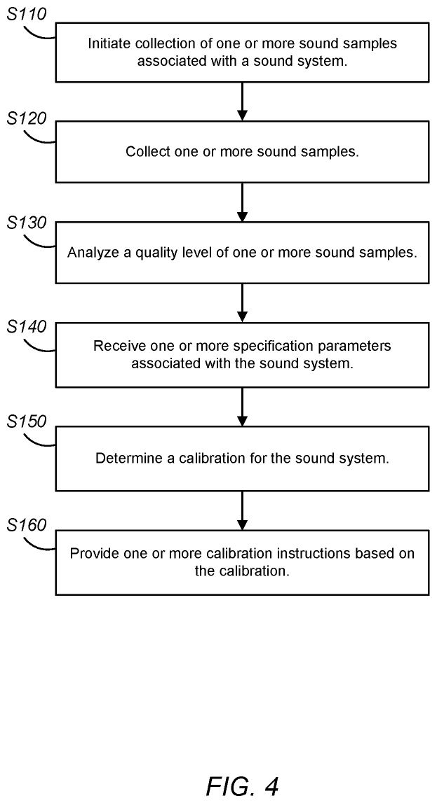

In one or more embodiments, a sound system configuration application of an ISP 1, a network resource 6, a network device 4, or any combination thereof can automatically perform a sound quality check of a site 350. For example, the ISP 1 can initiate the sound system configuration application at the sound system configuration device 4A so as to obtain one or more sound samples 312. The one or more sound samples 312 can be sent to the ISP 1 for analysis, the network resource 6, or both, for example, as discussed with reference to FIG. 4. In one or more embodiments, the ISP 1 can randomly request a sound quality check of one or more sites 350 so as to perform an analysis of one or more deployed sound systems 310. In one or more embodiments, the ISP 1 can perform a sound quality check based on content provided to a site 350. For example, the ISP 1 can request a sound quality check while particular content is streamed to a particular site 350. This type of sampling of sound systems deployed at various site can ensure that users are experiencing optimal sound quality for particular content.

In one or more embodiments, a user 330 can communicate with a sound system configuration device 4A, such as via a microphone 302A and/or a microphone 302B. For example, the user 330 can voice an instruction 305 (such as a question or command) to the sound system configuration device 4A. The sound system configuration device 4A, can process the instruction 305 and provide a response 306 to the user 330. For example, the user 330 can ask “What is the make and model of sound system?” In response the sound system configuration device 4A can query the network resource 4 for the information requested by user 330. For example, the sound system configuration device 4A can obtain any type of information associated with the sound system 310, such as an image, a purchase date, a username, an Internet protocol (IP) address, any other type of information, or a combination thereof. In one or more embodiments, the response 306 can include one or more calibration instructions, for example, any one or more of the calibration instructions 314.

FIG. 4 is a flow chart illustrating a method for providing calibration of a sound system in a sound system environment, for example, as illustrated in FIG. 3, according to one or more aspects of the present disclosure. Generally, an individual or user has difficulty in calibrating a sound system to provide an optimal or high quality sound output. A sound system calibration device and application, according to one or more aspects of the present disclosure, provides an interactive guidance, an automatic or dynamic calibration, a configuration or calibration instruction, or any combination thereof such that the QoE of a user is enhanced.

The sound system configuration device may be programmed with one or more computer-readable instructions such as a sound system configuration application that when executed by a controller cause the sound system configuration device to provide calibration of a sound system according to one or more embodiments so as to provide an enhanced QoE for user of the sound system. In FIG. 4, it is assumed that any one or more of the devices include their respective controllers and their respective software stored in their respective memories, as discussed above in connection with FIGS. 1-3, which when executed by their respective controllers perform the functions and operations in accordance with the example embodiments of the present disclosure (e.g., including providing a calibration for a sound system). While the steps S110-S160 are presented in a certain order, the present disclosure contemplates that any one or more steps can be performed simultaneously, substantially simultaneously, repeatedly, in any order or not at all (omitted).

At step S110, the sound system configuration device 4A can initiate collection of one or more sound samples 312 associated with a sound system 310. The initiation can be based on an instruction received from a network resource 6, a user input via (for example, a user interface of the sound system configuration device 4A or any other network device 4, a voice command, any other type of user input, or a combination thereof), a timer, a semaphore, an interrupt, any other factor or action, or any combination thereof. For example, the instruction can cause initiation of a sound system configuration application. In one or more embodiments, the initiation can comprise activating one or more network devices 4 coupled to the sound system configuration device 4A, for example, a receiver device 4C, a receiver device 4D, or both. For example, the cloud client configuration device 4A can send one or more instructions to a receiver device 4C and/or receiver device 4D to cause a speaker 304C and/or speaker 304D, respectively, to receive a sound sample.

At step S120, the sound system configuration application can collect one or more sound samples 312 from any one or more input sources as discussed with reference to FIG. 3. In one or more embodiments the sound samples 312 can be associated with any one or more output sources, such as any one or more speakers as discussed with reference to FIG. 3. In one or more embodiments, the one or more sound samples can be received at a sound system configuration device 4A, a network resource 6, or both.

At step S130, the sound system configuration application can analyze a quality level of the one or more sound samples 312. For example, the quality level can be compared to one or more specification parameters associated with the sound system 310, one or more predetermined thresholds, one or more previously stored calibrations, or any combination thereof. The quality level can be determined at a sound system configuration device 4A, a network resource 6, or both. For example, the sound system configuration device 4A can send the one or more sound samples 312 to a network resource 6 and the network resource 6 can analyze the quality level of the one or more sound samples 312.

At S140, the sound system configuration application can receive one or more specification parameters associated with the sound system 310. In one or more embodiments, the sound system configuration device 4A and/or network resource queries a uniform resource locator (URL) associated with the make, the model, or both of one or more components of the sound system 310, a network resource, any other repository, or any combination thereof to obtain the one or more specification parameters. In one or more embodiments, the one or more specification parameters can be received as one or more user inputs received via a user interface.

At step S150, the sound system calibration application determines a calibration for the sound system 310. For example, the calibration can be determined based on the one or more specification parameters, any one or more user inputs, one or more parameters received from a network resource and/or a repository, any other parameter, or any combination thereof. In one or more embodiments, the sound system configuration application can identify one or more current locations associated with any one or more components of the sound system 310, such as one or more speakers 320. The quality level analyzed in step S130 can be based on the one or more current locations. The current locations can be identified based on a user input or an analyzes of the one or more sound samples 312.

At step S160, the sound system calibration application can provide one or more calibration instructions based on the calibration. The calibration instructions can be provided as discussed with reference to FIG. 3. In one or embodiments, the calibration instructions are machine-readable instructions and/or instruction interpretable by any one or more components of the sound system 310, any one or more network devices associated with the sound system 310 (for example, a receiver device, a television, a soundbar, a smart media device, an input source, an output source, any other network device, or any combination thereof). In one or more embodiments, a user 330 receives a notification of the one or more calibration instructions. For example, the notification can be viewable via any output device associated with the sound system calibration device 4A, a client device 4B, any other display device, or any combination thereof. As an additional example, the notification can be sent electronically, for example, as an electronic mail message, to a user 330 such that the user 330 can view the notification on any type of client device or user device associated with the user 330.

According to one or more example embodiments of inventive concepts disclosed herein, there are provided novel solutions for managing, by a throttling management application, requests and/or responses associated with one or more network devices. Based, at least in part, on a throttling management configuration 320, certain requests and/or responses are bumped in a queue so as to provide an enhanced QoE for users of the network, especially a user that requires additional network resources or priority access to network resources.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A sound system configuration device for providing calibration of a sound system comprising:
a memory storing one or more computer-readable instructions; and
a processor configured to execute the one or more computer-readable instructions to:
collect one or more sound samples from an input source, wherein the one or more sound samples are associated with one or more sound system speakers of the sound system;
analyze a quality level of the one or more sound samples;
determine a calibration for the sound system based on the quality level, wherein the calibration comprises one or more calibration settings associated with the sound system; and
provide one or more calibration instructions based on the calibration.

2. The sound system configuration device of claim 1, wherein the processor is further configured to execute the one or more instructions to:
identify one or more current locations associated with the one or more sound system speakers, wherein the analyzing the quality level is based, at least in part, on the one or more current locations.

3. The sound system configuration device of claim 1, further comprising:
a plurality of microphones, wherein the input source comprises the plurality of microphones.

4. The sound system configuration device of claim 1, wherein the input source comprises a plurality of microphones associated with one or more network devices communicatively coupled to the sound system configuration device.

5. The sound system configuration device of claim 1, wherein analyzing the quality level comprises:
sending the one or more sound samples to a network resource; and
receiving from the network resource the quality level.

6. The sound system configuration device of claim 1, wherein determining the calibration comprises:
determining a location of at least one of the one or more sound system speakers.

7. The sound system configuration device of claim 1, wherein the processor is configured to execute one or more further instructions to:
receive one or more specification parameters associated with the one or more sound system speakers, wherein the determining the calibration is based, at least in part, on the specification parameters.

8. A method for a sound system configuration device for providing calibration of a sound system, the method comprising:
collecting one or more sound samples from an input source, wherein the one or more sound samples are associated with one or more sound system speakers of the sound system;
analyzing a quality level of the one or more sound samples;
determining a calibration for the sound system based on the quality level, wherein the calibration comprises one or more calibration settings associated with the sound system; and
providing one or more calibration instructions based on the calibration.

9. The method of claim 8, further comprising:
identifying one or more current locations associated with the one or more sound system speakers, wherein the analyzing the quality level is based, at least in part, on the one or more current locations.

10. The method of claim 8, wherein the input source comprises a plurality of microphones of the sound system configuration device, a plurality of microphones of one or more network devices coupled to the sound system configuration device, or a combination thereof.

11. The method of claim 8, further comprising:
receiving a request from a service provider to initiate the collecting the one or more sound samples.

12. The method of claim 8, wherein analyzing the quality level comprises:
sending the one or more sound samples to a network resource; and
receiving from the network resource the quality level.

13. The method of claim 8, wherein determining the calibration comprises:
determining a location of at least one of the one or more sound system speakers.

14. The method of claim 8, further comprising:
receiving one or more specification parameters associated with the one or more sound system speakers, wherein the determining the calibration is based, at least in part, on the specification parameters.

15. A non-transitory computer-readable medium of a sound system configuration device storing one or more instructions providing calibration of a sound system, which when executed by a processor of the sound system configuration device, cause the sound system configuration device to perform one or more operations comprising:
collecting one or more sound samples from an input source, wherein the one or more sound samples are associated with one or more sound system speakers of the sound system;
analyzing a quality level of the one or more sound samples;
determining a calibration for the sound system based on the quality level, wherein the calibration comprises one or more calibration settings associated with the sound system; and
providing one or more calibration instructions based on the calibration.

16. The non-transitory computer-readable medium of claim 15, wherein the one or more instructions when further executed by the processor, cause the sound system configuration device to perform one or more further operations comprising:
identifying one or more current locations associated with the one or more sound system speakers, wherein the analyzing the quality level is based, at least in part, on the one or more current locations.

17. The non-transitory computer-readable medium of claim 15, wherein the input source comprises a plurality of microphones of the sound system configuration device, a plurality of microphones of one or more network devices coupled to the sound system configuration device, or a combination thereof.

18. The non-transitory computer-readable medium of claim 15, wherein the one or more instructions when further executed by the processor, cause the sound system configuration device to perform one or more further operations comprising:
receiving a request from a service provider to initiate the collecting the one or more sound samples.

19. The non-transitory computer-readable medium of claim 15, wherein analyzing the quality level comprises:
sending the one or more sound samples to a network resource; and
receiving from the network resource the quality level.

20. The non-transitory computer-readable medium of claim 15, wherein analyzing the quality level comprises:
receiving one or more specification parameters associated with the one or more sound system speakers, wherein the determining the calibration is based, at least in part, on the specification parameters.
